(19) United States
(12) Patent Application Publication
(10) Pub. No.: US 2010/0107247 A1
(43) Pub. Date: Apr. 29, 2010

(54) SYSTEM AND METHOD FOR IDENTIFICATION, PREVENTION AND MANAGEMENT OF WEB-SITES DEFACEMENT ATTACKS

(76) Inventor: Oren Shani, Givataym (IL)

Correspondence Address: The Law Office of Michael E. Kondoudis, 888 16th Street, N.W., Suite 800, Washington, DC, 20006, US

(21) Appl. No.: 12/531,728

(22) PCT Filed: Mar. 12, 2008
(86) PCT No.: PCT/IL08/00341

§ 371 Date: Sep. 17, 2009

Related U.S. Application Data
(60) Provisional application No. 60/907,107, filed on Mar. 21, 2007.

(51) Int. Cl. G06F 11/00

(52) U.S. Cl. 726/22

(57) ABSTRACT

A system and method for identifying websites' defacement attacks by identifying of unauthorized network content pages or parts of pages that are defined as defaced-pages. The application may enable identifying defacing parts of a network content page by comparing the source code of the network content page with the source code of reference defaced-pages, which may be network content pages that were already identified as unauthorized defaced-pages and their source codes have already been stored in at least one database. Once a defacing-page is identified, the system may enable removing of the defacing-page and replacing it with the last corresponding network content page that has preceded the defacing one.

### CROSS REFERENCE TO RELATED APPLICATIONS

This application claims the benefit of International Patent Application no. PCT/IL2008/000341, filed on Mar. 12, 2008, which claims the benefit of U.S. Provisional Patent Application 60/907,107, filed on Mar. 21, 2007, both of which are incorporated herein by reference.

### FIELD OF THE INVENTION

The present invention generally relates to the field of network protection. More specifically, the invention relates to anti-defacement protection for network websites.

### BACKGROUND OF THE INVENTION

Website defacement occurs when an attacker breaks into a web server and defaces the hosted website. Once defaced, the website, or at least some of its pages, may no longer appear or function as it did before. Once a site is defaced, many associated damaging effects may occur such as, for example, loss of business, reputation damages, legal entanglements—when transactions, reports filling and the like fail to be available.

A U.S. Pat. No. 6,725,377 discloses a system for updating anti-intrusion software, in which a computer program updates anti-intrusion software on a computerized network device, which has an anti-intrusion monitor server. The computer program product is embodied on a computer readable medium that provides modified attack pattern information to an anti-intrusion monitor server on a computer network. The anti-intrusion software, comprises computer code that installs the modified attack pattern information onto a central anti-intrusion server; computer code that transfers the modified attack pattern information from the central anti-intrusion server to a push administration computer connected to the Internet, the push administration computer being capable of transmitting attack pattern information to the anti-intrusion monitor server using push technology.

A patent application number US 2002143963 discloses an apparatus for enhancing the security of a web server from intrusive attacks in the form of HTTP (Hyper Text Markup Language) requests. This is accomplished by comparing an incoming request with a predefined list of attack signatures, which comprises files, file categories and IP addresses of known hackers. Action is then taken to reject any requests wherein a positive comparison is determined.

A patent application number US2004073800 discloses an adaptive intrusion detection system, where a vulnerability assessment of one or more computers or hosts is performed to determine whether vulnerabilities exist on the computers or hosts. This is accomplished by using existing vulnerability determination or vulnerability assessment information that can be continually updated. Attack signatures, which can also be continually updated, are identified and correlated with the specific vulnerabilities identified. One or more designated IP sessions associated with attempted vulnerability exploitation are then inhibited or disconnected.

Many of the defacing attacks that manage to surpass the protective programs mange to deface web pages and update pages with defacing data inserted through.

### SUMMARY OF THE INVENTION

The present invention discloses a system and method for identifying websites' defacement attacks by identifying of “defaced-pages”, which are network content pages that are identified as unauthorized by the system; and managing of source code data related to those defacements of those defaced-pages. The source code of the pages may be any network code known in the art such as, for example, Hyper Text Markup Language (HTML) code.

According to some embodiments of the invention, every newly updated network content page (referred to hereinafter as “last-page”)

According to some embodiments of the invention, the system may comprise at least one Defaced-pages Database (DPD) and a software application. The application may enable identifying defacing parts of a network content page by comparing the source code of the network content page with the source code of reference defaced-pages, which may be network content pages that were already identified as unauthorized defaced-pages.

According to some embodiments of the invention, the system may additionally comprise a “last-page database” (LPD) enabling to store newly updated network content pages of at least one predefined website.

According to some embodiments of the invention, the application may comprise:
a source code unit enabling retrieving and reading of network content pages, comparing these pages' source code to the source code of corresponding “last-pages”, which are network content pages that have been updated in the website, to identify changes in these last-pages;
a defacement identification unit that enables receiving network last-pages that are identified as changed by the source code unit, identification of the changes in the last-pages, comparing the source code of the identified changed last-pages to source codes of defaced-pages, which are network content pages, which were identified as unauthorized defaced-pages and are stored in the database (in the DPD);
a probabilities unit that enables retrieving and scanning source codes of network content pages, identifying “attack parameters”, weighing each identified parameter, calculating a defacing probability and deciding upon unauthorized defaced-pages according to the value of the probability; and
a page management unit that enables updating of changed last-pages that were identified as not defaced-pages, replacing changed last-pages that were identified as defaced-pages with the last updated network content page and notifying at least one of the application's users, once an unauthorized defacement is identified.

According to some embodiments of the invention, the notification regarding an identification of a defacement may be transmitted only to predefined users such as administrators of the system, for example.

According to some embodiments of the invention, once a defacing-page is identified, the system may enable removing of the defacing-page and replacing it with the corresponding last updated network content page that has preceded the defacing one.

According to some embodiments of the invention, the application may additionally comprise an archive that enables storage and display of the source code of all the updated last-pages to allow replacing each last-page with a corresponding newly retrieved network content page once the page is identified as non-defacing-page.

According to some embodiments of the invention, the system may additionally comprise at least one server and a finder, which may be a software application that may enable: (i) retrieving websites and their corresponding network content pages through at least one network communication; (ii) identifying new unauthorized defaced-pages and websites; (iii) storing these defaced-pages and corresponding websites by adding them to at least one database that is associated with the system; and (iv) sending new updates and notifications to users.

According to some embodiments of the invention, the system may additionally comprise users' databases comprising of defaced-pages' codes defined as signatures of the unauthorized defaced-pages; and a main database comprising all accumulated defaced-pages' codes.

According to some embodiments of the invention, the system may enable updating of the users' databases using the main database.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein:

FIG. 1 is a schematic illustration of a system for identification and management of defaced-pages, according to some embodiments of the present invention;

FIG. 2 is a flowchart that schematically illustrates a sanity check method for identification of defaced-pages, according to some embodiments of the present invention;

FIG. 3 is a flowchart that schematically illustrates a sanity check method for identification of defaced-pages, according to additional embodiments of the present invention;

FIG. 4 is a schematic illustration of system for harvesting of defaced-pages from a layout of network sites and users, according to some embodiments of the present invention; and

FIG. 5 is a flowchart that schematically illustrates a process of data harvesting for defaced-pages, according to some embodiments of the present invention.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTIONS OF SOME EMBODIMENTS OF THE INVENTION

The present invention comprises a system and a method for protecting data network content pages from unauthorized changes such as defacements, usually made by hackers, using a software application 100. Application 100 may enable retrieving the source code of at least some of the network content pages of a website, checking for changes in the source code and checking whether these changes indicate a defacement of the page, which is defined as an unauthorized change, defined hereinafter as “a defacing-page”. Once a defacing-page is identified, the system may notify at least one predefined administrator of the site or any other user or group of users regarding this identification.

A network content page may be any page of a website that has content, links, functionalities, as known in the art such as HTML pages, for example. The network content pages are managed by a predefined a source code (e.g. HTML code), as known in the art.

A defaced-page is a page that corrupts either the content or the functionality of a network content page such as a web page (e.g. the HTML script of a web page). The defacing is usually done by hackers who try and vandalize a website or insert their own messages into the pages (e.g. the hacker's name, religious statements etc.).

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

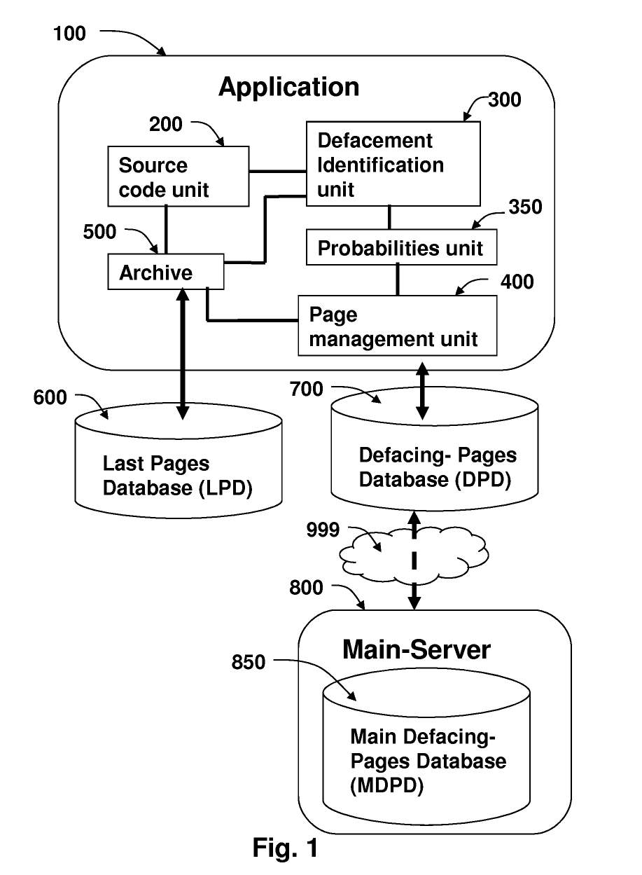

FIG. 1 is a schematic illustration of a system for identification and management of defaced-pages, using an anti-defacement software application 100, according to some embodiments of the present invention. Application 100 may comprise:
a source code unit 200 that may enable retrieving and reading of data network content pages, comparing these pages' source code to “last-pages'” source code to identify a change in the page. The Last-page is defined herein as the last update of the same network content page. Source code unit 200 may repeat the steps of retrieving, reading comparing, or at least some of these steps for each network content page of each site defined and introduced to the system.
a defacement identification unit 300 that may enable identification of changes in the last-pages, comparing the source code of the changed last-pages to source codes of network content pages that are defined in the system as defaced-pages, which were identified as related to unauthorized defacements.
probabilities unit 350 that enables retrieving and scanning the last-page's source code, identifying “attack parameters”, weighing each identified parameter, calculating a Defacing Probability (DP) and deciding upon a defacing page according to the value of the DP (meaning, for example, that once the DP value exceeds the threshold DP—the page is identified as a defacing-page).
a page management unit 400 that may enable updating of changed last-pages that were identified as not defaced-pages, replacing changed last-pages that were identified as defaced-pages with the last update of the corresponding network content page (the former “last-page”) and notifying at least one of the application's users once an unauthorized defacement is identified.
an archive 500 that may enable storage and display of all last-pages' source code. Once a changed last-page is identified as non-defacing-page—meaning that application 100 has not identified this page as a defacing-page—archive 500 may enable replacing the current last-page with the new retrieved corresponding network content paged, defining this page as the new last-page.
Last-pages Database (LPD) 600 a database that may be situated at the user's computerized network device (e.g. laptop, cellular phones, I-Pods, personal computers and any computerized device known in the art that enables network communication through at least one communication network 999), an appliance, a main server 800, or any other computer, and comprise all the last-pages saved by application 100.
Defaced-pages Database (DPD) 700 that may be situated at the user's computer, the appliance, a main server 800, or any other computer The DPD 700 may comprise known reference defaced-pages, the reference defaced-pages' source codes, and associated data.
and comprise reference defaced-pages, which are a list that comprises source codes of pages that were identified as defaced-pages by application 100, other sources of information or both, or manipulations to source codes or other sources of information or both.
Main Defaced-pages Database (MDPD) 850 that may be situated at a main server 800, the appliance, or any other computer and comprise a reference-defaced-pages-list, which is a list that comprises source codes of pages that were identified as defaced-pages by a number of information sources. Main server 800 may transmit defaced-pages' information and source codes through at least one communication network 999.

According to some embodiments of the present invention, “attack parameters” may be any part of the source code or the content of the last-page that can be identified as unauthorized. For example, the amount of changes made in the page, curse words (unauthorized words, such as vulgar words) identified in the content, at least one name that is identified as a hacker's name—when comparing to hackers' known names database, and the like.

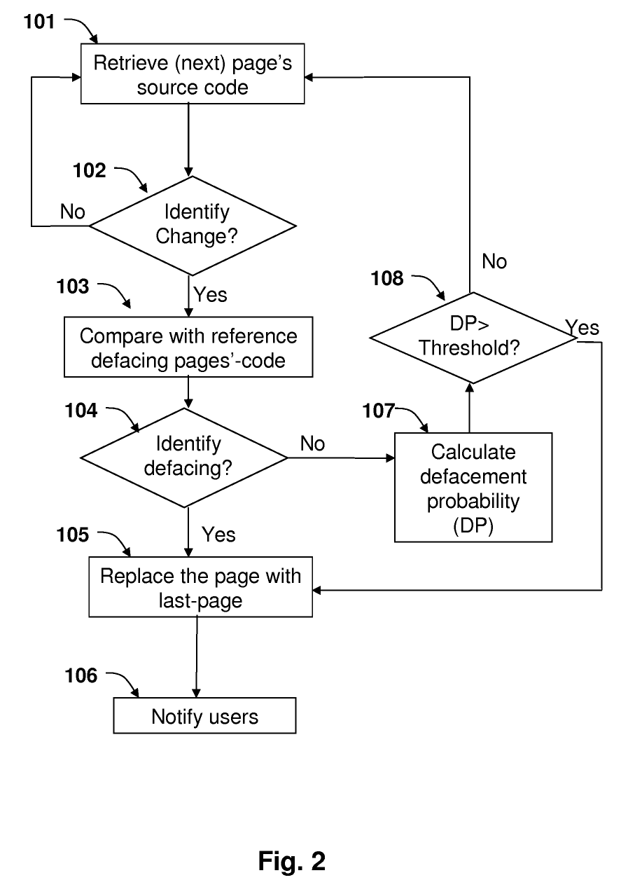

FIG. 2 is a flowchart that schematically illustrates a sanity check method for identification of defaced-pages, using application 100, according to some embodiments of the present invention. The method comprises the steps of:
Retrieving the last-page's source code 101—where source code unit 200 retrieves the source code of a newly updated last-page;
Identifying changed last-page condition 102—where source code unit 200 checks if at least part of the last-page's source code has been changed.
Upon identifying a change in the last-page—comparing the last-page's source code with source codes of known defaced-pages 103, where the defaced-pages may be network content pages already identified as defaced-pages and that may be retrieved by defacement identification unit 400 from DPD 700, MDPD 850 or both.
Identifying defacing-page condition 104, where if the last-page is not identified as a defacing-page—probabilities unit 350 may calculate a probability value for the page to be a defacing-page 107.
If the Defacing Probability (DP) is larger than a predefined threshold value 108 or if the page is identified as a defacing-page then page management unit 400 enables replacing the defacing-page with the corresponding last updated last-page 105 stored in LPD 600 (prior to the corresponding new page identified as a defacing-page); and
notifying the user and/or an administrator 106 regarding the identification of a defacing-page code.

According to some embodiments of the present invention, when a defacing-page is identified—the application may search for defacing-parts of the defacing-page and replace them with the last saved version of corresponding parts from the corresponding last saved version of the content page, rather than replacing the entire page.

Alternatively, of course, the application 100 may replace the entire page without searching or identifying parts, or replace the entire page while searching for the defacing-parts for future reference and recording.

According to some embodiments of the present invention the identification of a change in the last-page, a defacing-page or both may be carried out by using Hash functions such as a cryptographic Hash function, for example, to encode the source code of the last-page and comparing the Hash encoding of the input page to the Hash encoding of the last-page and/or to the Hash encodings of the reference defaced-pages.

The Hash encoding or Hash function is a mechanism enabling to transform data (e.g. lines of HTML source code) into a substantially much smaller sequence of numbers and/or characters which can be read, encoded like a signature and decoded to read the full code again.

According to some embodiments of the present invention, the systems may first check each newly updated last-page of each specific website defined in the system for defaced-pages—and only upon checking all of the content pages of the website, notifying the user regarding identified defaced-pages.

According to some embodiments of the present invention, upon identifying a defacing-page, the system may automatically update DPD 700 and/or MDPD 850 with the source codes of the identified defacing-page.

According to some embodiments of the present invention, application 100 may be carried out through a network appliance or installed at the user's end computer, where server 800 used for running application 100 and searching through the databases may be the appliance or user's web-server or the any of the sites' servers. The network appliance may monitor the web-server. If application 100 runs through the user's web-server, the last-pages may be checked for defacements prior to loading the last-page. Therefore, application 100 may prevent server 800 from uploading the last-page in case application 100 identifies it as a defacing-page or in case application 100 identifies elements in the not-yet-uploaded last-page that may be suspected as a defacing objects such as defacement photos and defacement text, for example.

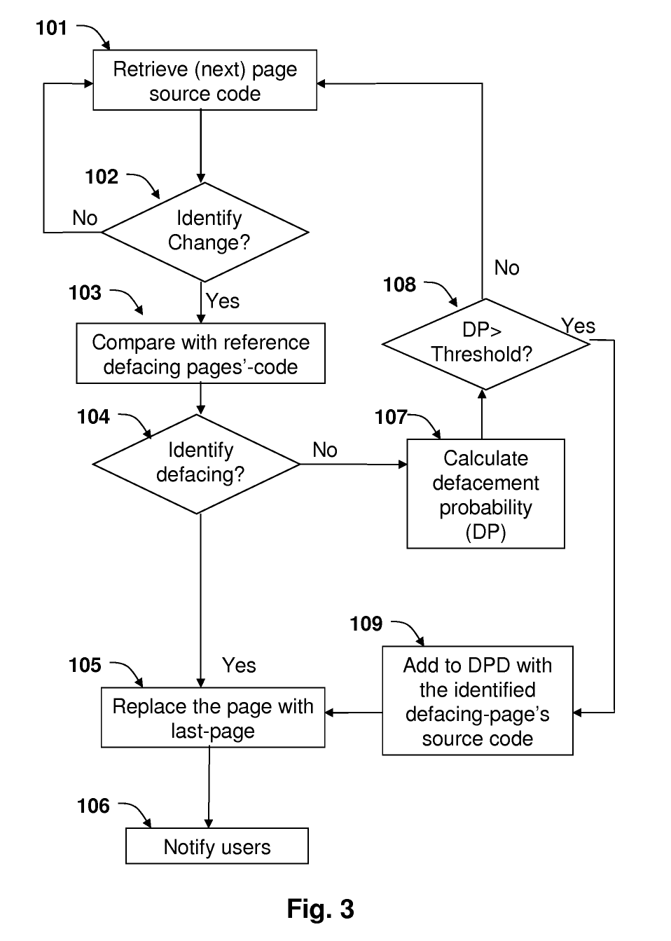

FIG. 3 is a flowchart that schematically illustrates a sanity check method for identification of defaced-pages, according to additional embodiments of the present invention. Once a defacing-page is identified by probabilities unit 350—the new identified defacing-page (that did not appear in DPD 700 and may not appear in MDPD 850)—application 100 may update at least one database regarding the new identified defacing-page. For example, as illustrated in FIG. 3, once the Defacing Probability value is bigger than a threshold DP value 108, the system identifies the last-page as a defacing-page and may then add the newly identified defacing-page and its source code to DPD 700 by saving it 109 in DPD 700.

According to some embodiments of the present invention, once DPD 700 is updated with a new defacing-page's source code and other related data—DPD 700 may update other databases that contain defaced-pages information such as, for example MDPD 850, other users' databases that are associated with the application 100 etc.

According to some embodiments of the present invention, application 100 may retrieve reference defaced-pages from DPD 700 for comparing the changed pages with all reference defaced-pages stored in DPD 700. MDPD 850 may be used for updating DPD 700 when other users of the network identify unknown new defaced-pages, using various techniques and rumors to identify these defaced-pages.

According to other embodiments of the invention, the previously-identified and stored defaced-pages' source codes may be retrieved directly from MDPD 850, where application 100 is connected only to MDPD 850 of main server 800, where the system may not comprise DPD 700.

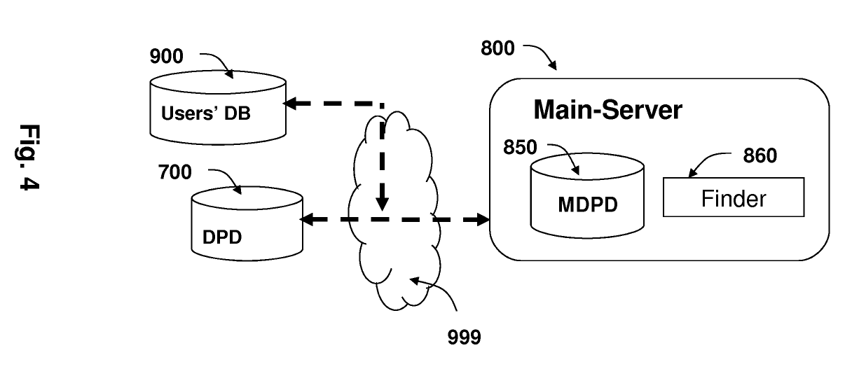

FIG. 4 is a schematic illustration of a system for harvesting of defaced-pages from a layout of network sites and users, according to some embodiments of the present invention. The system may comprise main server 800, MDPD 850, a finder 860, which is a software application that may be situated in main server 800, or any other server, at least one DPD 700 of at least one user and at least one users' database 900. Finder 860 may enable retrieving sites and their network content pages (e.g. web pages) from any web source through at least one communication network 999, identifying new defaced-pages and sites, storing these sites, content pages and their source codes by adding them to MDPD 850 and sending new updates to users' DPDs 700.

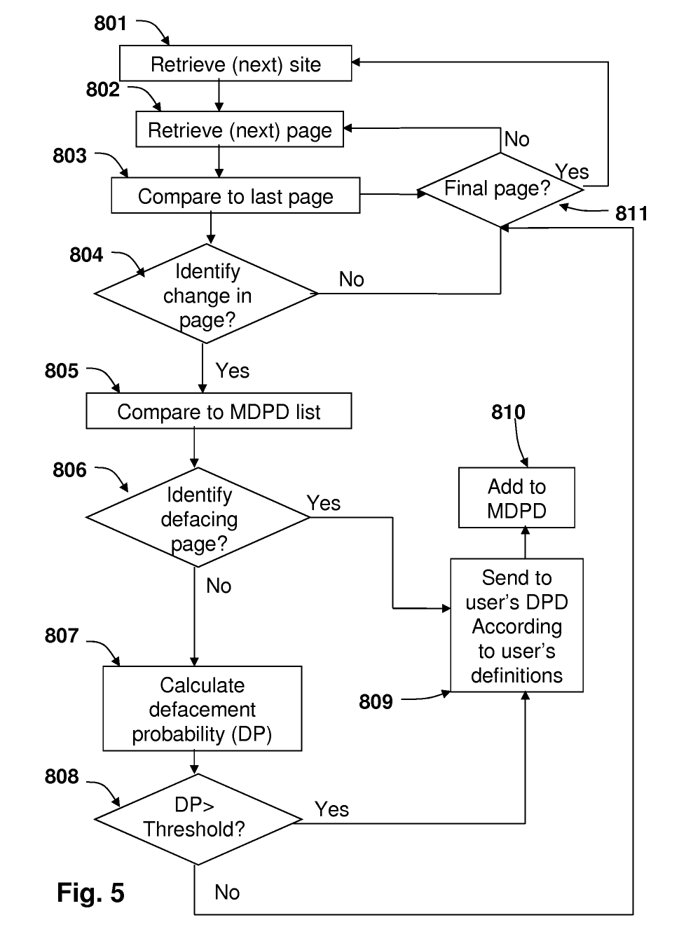

FIG. 5 is a flowchart that schematically illustrates a process of data harvesting for defaced-pages using finder 860, according to some embodiments of the present invention. The process may comprise the steps of:
Retrieving a site 801—where finder 860 may retrieve a site from the network 999.
Retrieving a page 802—where finder 860 may retrieve each last-page of each site and execute the process for each page.
Checking for changes in last-page 803 by comparing the last-page's source code to the source code of the last updated corresponding network content page (the former “last-page”) of the same site that may be stored in one of the main server's 800 databases.
If changes in the last-page are identified—comparing the retrieved page's source code to source codes of saved defaced-pages 805.
If the last-page is not identified as a defacing-page by the comparison with the saved defaced-pages 806—finder 860 may check for defacements by calculating DP 807.
If the DP is larger than a predefined threshold DP 808, the system identifies the last-page as a defacing-page.
If a defacing-page is identified—the system may send the newly identified defacing-page and its related data to at least part of the network 999 users 809 and application 100 users' databases such as to DPD 700.
Upon identifying a new defacing-page—finder 860 may add defacing-page 810 to MDPD 850.
If the page is identified as not being defacing—the system may move on to the next page 811 of the website. If the page is the final page of the website—the system may begin to check the next website, depending on the system's definitions.

According to some embodiments of the present invention, application 100 may provide a user interface allowing the user to define specific network content pages and websites for which application 100 may check for defaced-pages or defacing-parts.

While the invention has been described with respect to a limited number of embodiments, these should not be construed as limitations on the scope of the invention, but rather as exemplifications of some of the preferred embodiments. Those skilled in the art will envision other possible variations, modifications, and applications that are within the scope of the invention. Accordingly, the scope of the invention should not be limited by what has thus far been described, but by the appended claims and their legal equivalents.

What is claimed is:

1. A method for protecting network content pages from unauthorized changes the method comprising:
monitoring changes of at least one last-page, which is a last updated network content page of at least one website;
comparing source code of the at least one last-page with reference source codes of defaced-pages, which are network content pages that were identified as related to unauthorized defacements;
wherein a network content page is defined as defacing-page when at least part of a compared source code of the content page is identical to at least a part of a source code of a corresponding unauthorized defacing-page.

2. The method of claim 1 further comprising replacing the identified unauthorized defacing-age with the last update of a corresponding network content page that has preceded the content page identified as a defacing-page.

3. The method of claim 1 wherein the monitoring of changes in the at least one new updated last-page is carried out by comparing of the source code of the at least one last-page with the source code of a corresponding last saved version of the last-page of the website.

4. The method of claim 1 wherein the source codes of the newly updated last-pages, which were identified as defaced-pages, are stored in a defaced-pages database.

5. The method of claim 1 further comprising protecting of network content pages by identifying of unauthorized defaced-pages wherein said identification is carried out by using a software application installed in users' computerized network devices.

6. The method of claim 1 further comprising calculating a defacing probability value for the last-page, wherein the defacing probability value is calculated according to a predefined algorithm,
wherein once the defacing probability value exceeds a predefined threshold defacing probability value, the corresponding last-page is identified as a defacing-page and the last-page is replaced with the last corresponding network content page.

7. The method of claim 6 wherein the algorithm is updated according to accumulated statistical data.

8. The method of claim 7 further comprising adding the source code of the last-page that has been identified as a defacing-page to at least one database of defaced-pages.

9. The method of claim 1 further comprising notifying at least one user upon identification of an unauthorized network page.

10. The method of claim 1 further comprising updating users' databases and applications regarding new identified defaced-pages, wherein the updating is carried out by using a main database comprising substantially all accumulated identified unauthorized pages.

11. The method of claim 1 further comprising harvesting of defaced-pages, wherein the harvesting is a process of going through a multiplicity of network content pages of a multiplicity of websites to identify defacement attacks,
wherein the process comprising retrieving a multiplicity of websites and retrieving of at least some of the network content pages associated with each of the websites and identifying unauthorized defaced-pages that are associated with each website.

12. The method of claim 1 wherein the identifying of a defacing-page is carried out by using at least one encoding functions to encode the source code of the last-page and comparing the encoding of the last-page to the encoding of the to the encodings of reference defaced-pages, wherein said reference defaced-pages are also encoded according to the same encoding function.

13. The method of claim 12 wherein said encoding function is at least one Hash function, which is a mechanism enabling to transform data into a substantially much smaller sequence of characters which is defined as a signature of the page.

14. A system for identification of network content pages with unauthorized changes defined as defaced-pages, the system comprising:
a software application for monitoring of network content pages of at least one website and identifying defaced-pages by comparing a source code of each network content page with a source code of reference defaced-pages, which are network content pages that were already identified as defaced-pages; and
at least one Defaced-pages Database (DPD) comprising known reference defaced-pages, the reference defaced-pages' source codes, and associated data;
wherein the application enables identifying a network content page of a website as a defacing-page when at least part of the network content page's compared source code is identical to at least a part of a source code of a reference defacing page.

15. The system of claim 14 further comprises a Last-page Database (LPD) for storing updated last-pages of a predefined website, which are the last version of the network content pages of the website.

16. The system of claim 14 wherein the application comprises:
a source code unit for retrieving and reading source codes of network content pages, identifying changes in last-pages, which are newly updated network content pages, wherein said identifying of changes is carried out by comparing source codes of a last version of a network content page with a corresponding newly updated last-page's source code;
a defacement identification unit for receiving network pages that are identified as changed by the source code unit, comparing source code of the identified changed last-pages to source codes of defaced-pages, which are stored in the DPD;
a page management unit for updating of changed last-pages that were identified as not defaced-pages, replacing changed last-pages that were identified as defaced-pages with the last version of a corresponding network content page and notifying at least one of user of the application regarding an identified defacing-page.

17. The system of claim 16 wherein the application further comprises an archive for storage and display of all last-pages' source codes, to allow replacing the last-page with the newly updated network content page once the network content page is identified as not defacing-page.

18. The system of claim 16 wherein the application further comprises a probabilities unit for retrieving and scanning network content pages' source codes, identifying attack parameters, weighing each identified attack parameter, calculating a defacing probability, and deciding upon a defacing-page according to the value of the probability.

19. The system of claim 16 further comprising at least one server, and a finder, which is a software application for: retrieving websites comprising network content pages through at least one communication network; identifying new defacing-pages of the websites; storing these websites and the source codes of their defaced-pages in at least one database that is associated with the system; and sending notifications to users.

20. The system of claim 16 further comprising users' databases comprising reference defaced-pages, the reference defaced-pages' source codes, and associated data.
wherein the system enables updating of the users' databases regarding new identified defaced-pages, using the main DPD.
